(19) United States
(12) Patent Application Publication
(10) Pub. No.: US 2009/0132320 A1
(43) Pub. Date: May 21, 2009

(54) METHOD FOR GENERATING A CONSTRAINT LOADING PLAN

(75) Inventor: Baruch Ismail Saeed, Berkeley, CA (US)

Correspondence Address: SUGHRUE MION, PLLC, 2100 PENNSYLVANIA AVENUE, N.W., SUITE 800, WASHINGTON, DC, 20037, US

(73) Assignee: Maxager Technology, Inc.

(21) Appl. No.: 12/036,104

(22) Filed: Feb. 22, 2008

Related U.S. Application Data
(63) Continuation-in-part of application No. 11/944,383, filed on Nov. 21, 2007.

(51) Int. Cl. G06Q 10/00

(52) U.S. Cl. 705/8; 705/7

(57) ABSTRACT

A method for generating a constraint loading plan. The method determines at high accuracy which products and sales orders to load on which constraints in order to gain a maximum profit. The constraints include, but are not limited to, an assets-based constraint, emissions limits, a resource-based constraint, a market-based constraint, and so on. Specifically, the method generates an optimized loading plan of sales orders that were loaded and a least opportunity cost loading plan of sales orders that were not loaded. In accordance with one embodiment, the method generates a chart that shows, for each constraint (or a set of constraints), the cash contribution per constraint unit versus the number of cumulative constraint units. In accordance with another embodiment, the method computes the marginal cash contribution to determine the additional cash contribution that could be made if a specific constraint is relaxed.

### CROSS REFERENCE TO RELATED APPLICATIONS

This application is a continuation-in-part of U.S. application Ser. No. 11/944,383 filed on Nov. 21, 2007 assigned to common assignee and which is hereby incorporated herein in its entirety by this reference thereto.

### TECHNICAL FIELD

The present invention generally relates to enterprise information systems, and more particularly, to a method for generating a constraint loading plan.

### BACKGROUND OF THE INVENTION

In the competitive business climate, there is a profit driven motive to maximize the profitability of goods and services that are provided or marketed to customers. Enterprises typically use business planning to make decisions in order to maximize profits.

Typically, business planning is the process of acquiring market and operational information from business units in the organization in order to create, integrate, and execute the next series of operational plans and financial budgets. The process normally entails the gathering of information by each logical organization of the business from logical sub-organizations, which in turn, themselves gather information from their sub-organizations, to a desired level of abstraction, usually at customer, product and process levels.

The business information is often aggregated from multiple data sources, such as individual spreadsheets, online transaction processing (OLTP) applications, and specialized databases, called operational data stores (ODS). The OLTP applications are enterprise systems that manage a company's basic transactions, such as supply chain management (SCM), customer relationship management (CRM), and enterprise resource planning (ERP). Using the business planning tools, managers can correctly make decisions that optimize resource allocation in order to maximize profits. For example, key decisions include, but are not limited to, determining which new products to introduce, which suppliers to use, which capital investments to make, and what prices to charge. These decisions are subject to constraints such as the maximum quantities of products that may be sold to customers, contractually-obligated minimum quantities of products to provide to customers, maximum allocations of resources from suppliers, regulatory limits on natural resource usage and emissions, and so on.

The constraint loading problem is usually stated as finding of the optimal assignment of sales orders to constraints, such that the total profit is maximized and all constraints are satisfied. The constraints may include, for example, a market-based constraint, i.e., a maximum quantity to sell to a specific customer; a resource-based constraint, i.e., the maximum amount of available material, and an asset based-constraint, i.e., machine capacities, an emissions limit (or cap), and so on.

A prime example where the constraint loading problem may be feasible is for emissions cap loading. Due to increasing environmental awareness, regulation and social pressure, manufacturers such as those with chemical processes and fossil fuel-burning plants must take into consideration environmental constraints when implementing their business plans. To control the amount of pollution, a central authority sets a cap on the amount of a pollutant that can be emitted. Companies or other groups are issued an emission cap, i.e., the maximum amount of mercury that a chemical plant may emit. The emissions cap loading problem is to find of the optimal production of sales orders (or products) such that the total profit is maximized and production is maintained within an allowed emissions cap.

In the related art, there are many conventional tools, such as linear programming or heuristic methods like material requirements planning, for implementing a business planning process to create a loading plan. These tools are often inadequate as they typically attempt to minimize cost or merely to find a feasible plan, rather than attempting to maximize profit by establishing the quantities and loadings of all sales orders. Some of the conventional tools also try to maximize the profit by usually aggregating product volumes and using averaged prices. However, such tools do not use detailed sales orders with their specific quantities and prices. That is, these tools typically determine only the quantities of products to load on each constraint, e.g., which products to produce on each machine. This result is insufficient, especially in production plants serving many customers with a large number of different product types and multiple interactive production flows.

Furthermore, conventional tools are incapable of solving the loading problem when the asset, environmental, market, resource and other similar constraints are taken together. That is, if such tools can find the optimal loading, the existence of multiple constraints obscures the rationale for the loading. As a result, managers cannot make accurate strategic and tactical decisions regarding, for example, the production flows and constraint loading.

In view of the foregoing, it would be advantageous to provide a more efficient solution for generating a constraint loading plan.

### BRIEF DESCRIPTION OF THE DRAWINGS

FIG. 1 is a flowchart describing the method for generating an optimized constraint loading plan in accordance with an embodiment of the present invention.

FIGS. 2A through 2E are the output tables of the constraint loading plan of products.

FIG. 3 illustrates a flowchart describing the processes for generating the loading plan of sales orders with quantities loaded.

FIGS. 4A and 4B are the output tables of the loading plan of sales orders with quantities loaded.

FIGS. 5A and 5B are the output tables of the loading plan of sales orders with quantities not loaded.

FIG. 6 is an output table that includes the details of the constraint loading plan generated by the present invention.

FIG. 7 is an emissions cap loading chart generated by the present invention.

### DETAILED DESCRIPTION OF THE INVENTION

In order to overcome the shortcomings of prior art solutions, a method for generating a constraint loading plan is provided. The method determines at high accuracy which products and sales orders to load on which constraints in order to gain a maximum profit. The constraints include, but are not limited to: assets, emission limits, natural resource limits, maximum demands, and so on. Specifically, the method generates an optimized loading plan of sales orders that were loaded and a least opportunity cost loading plan of sales orders that were not loaded. In accordance with one embodiment, the method generates a chart that shows, for each constraint (or a set of constraints), the cash contribution per constraint unit versus the number of cumulative constraint units. In accordance with another embodiment, the method computes the marginal cash contribution to determine the additional cash contribution that could be made if a specific constraint is relaxed.

The intended meaning of some of the terms used hereinafter will now be mentioned. A “sales order” refers to a combination of product, customer, and deliver-to location with an associated price and a quantity. A “product” shall refer to an item to be loaded within a constraint limit. A product may be a composed of other products, such as subassemblies, components or raw materials, it may require the use of non-storable services such as a BTU of energy or a person-day of consulting labor, and its production may result in emissions, such as carbon dioxide and mercury. The quantity of a product is measured in its particular “units”.

A “constraint” may refer to a restriction condition that applies on the production of products. A constraint may be, but is not limited, an asset capacity (i.e., an asset-based constraint), an emissions limit (i.e., an emissions cap or number or allowances), a resource limit (i.e., a resource-based constraint), a market demand (i.e., a market-based constraint), and so on. The limit of a constraint is measured in “constraint units”.

A “process step” refers to an operation in a production process needed to produce a product. A process step may include a “constraint group”, which must be loaded. The constraints within a constraint group are alternatives. The term “loaded” means that constraint units are loaded (rather than produced) to a constraint. For example, the quantity's emissions can be loaded onto an emissions constraint, or the amount of revenue loaded onto a revenue target.

A “route” refers to a sequence of process steps, and each process step can involve one or more constraints. The combination of a route, process step, constraint, and product has an associated “constraint intensity” measured in constraint units per product units. The constraint intensity defines how much the processing of the product at the process step of the route contributes to a constraint. If the constraint intensity equals to zero or is null, the constraint does not apply.

A “reduced cost” is a linear programming term indicating the amount of the cost or price of a sales order needs to be adjusted in order to optimally load the sale order on a constraint. The reduced cost reflects both sales order specific costs (e.g., revenue and production costs) and systemic costs (e.g., opportunity cost of resources that would have otherwise been allocated to other sales orders).

A “marginal cash contribution per unit” shall refer to the marginal value of selling one more unit of a sales order's product. A “marginal cash contribution per constraint unit” shall refer to the marginal cash that could be generated by relaxing a constraint's limit (i.e., increasing or decreasing a constraint unit).

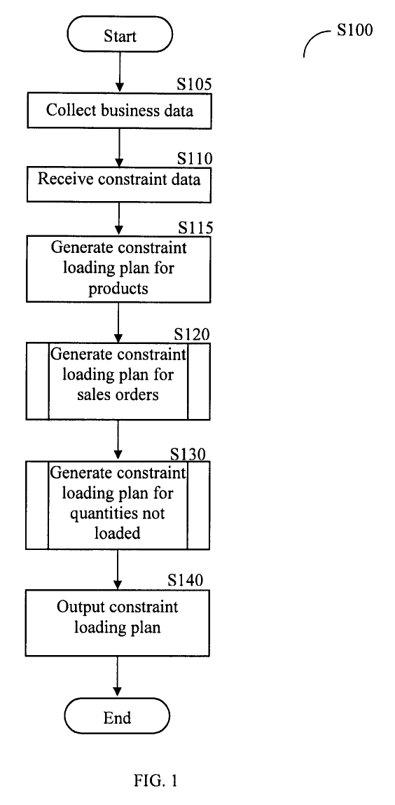

FIG. 1 shows an exemplary and non-limiting flowchart 100 describing the process of generating an optimized constraint loading plan implemented in accordance with an embodiment of the present invention. At S105, the process receives as an input business data, from a production plant and a marketing and sales organization, collected from multiple data sources, such as individual spreadsheets, online transaction processing (OLTP) applications, and specialized databases, called operational data stores (ODS). The input business data may include financial data (e.g., production and shipping costs), marketing data (e.g., products), sales data (e.g., sales orders and their customers, products, prices and quantities). The business data may be based on historical or projected details. At S110, the process receives constraint information including constraint applicability to certain products, constraint units required per product unit and constraint limits.

At S115, an optimized plan for loading products to constraints is generated. That is, this step determines the optimal assignment of products to process steps and routes such that the production of these products will satisfy the constraints. The optimized plan is loaded into a mathematical programming (e.g., a linear programming) optimization engine based on the input business data. The linear programming optimization engine determines the best feasible values that satisfy a set of constraints that represent various business factors and at the same time maximize the cash contribution measured by an objective function. The business factors may be related to, for example, demand, production flow, capacity, shipping, and attribute grouping. An example for the execution of S115 may be found in U.S. patent application Ser. No. 12/035,207 entitled “A method for constrained business plan optimization based on attributes”, assigned to common assignee and is hereby incorporated by reference in its entirety.

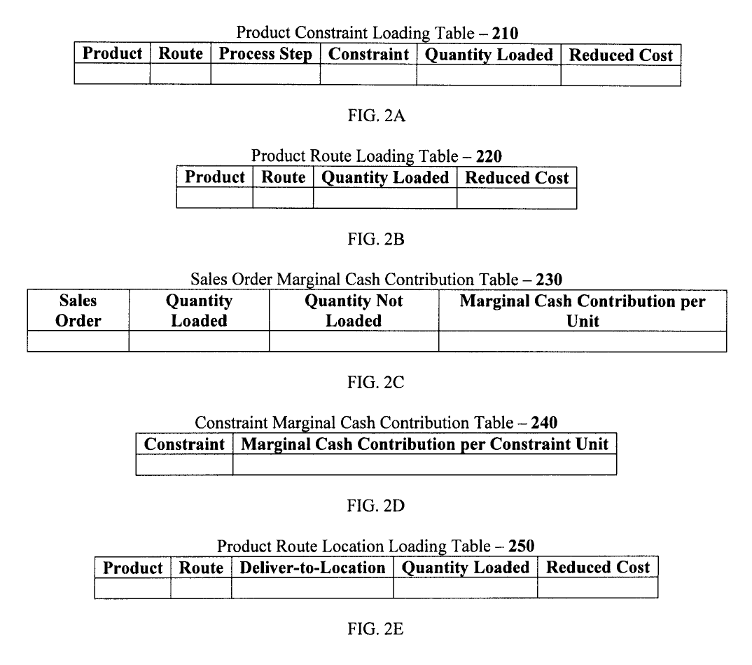

The outcome of S115 is at least a set of Constraint Loading tables. Specifically, as shown in FIG. 2A, a Constraint Loading table 210 describes the assignment of products to routes, process steps, and constraints. In addition, the table 210 includes the quantity loaded for this product and its reduced cost. The outputs of S115 may further include a Product Route Loading table 220 (FIG. 2B), a Sales Order Marginal Cash Contribution table 230 (FIG. 2C), a Constraint Marginal Cash Contribution table 240 (FIG. 2D), and a Product Route Location Loading table 250 (FIG. 2E). Table 210 includes the fields: product, route, process step, constraint, quantity loaded, and reduced cost. Table 220 includes the fields: product, route, quantity loaded, and reduced cost. Table 230 includes the fields: sales order, quantity loaded, quantity not loaded, and marginal cash contribution per unit. Table 240 includes the fields: constraint and marginal cash contribution per constraint unit. Table 250 includes the fields: product route, deliver-to-location, quantity loaded, and reduced cost. These tables provide the business with an optimized plan.

The process described at S115 can be easily adapted by a person skilled in the art to develop a multi-period plan, where the step S115 is individually applied to each of the periods with some exceptions discussed below.

At S120, an optimized plan for mapping the loaded sales orders' quantities to constraints is determined. A sales order includes a product to be delivered to a customer at a location, and therefore, the loading of a sales order is different from a loading of a product. As a constraint may not have sufficient slack remaining to produce all of a product's units of a sales order, the production may be distributed across two or more constraints at a process step or across two or more routes. Therefore, at S120, a Sales Order Route Loading table and a Sales Order Constraint Loading table are generated. Furthermore, if a constraint lacks sufficient slack, only a portion of a sales order's quantity may be loaded.

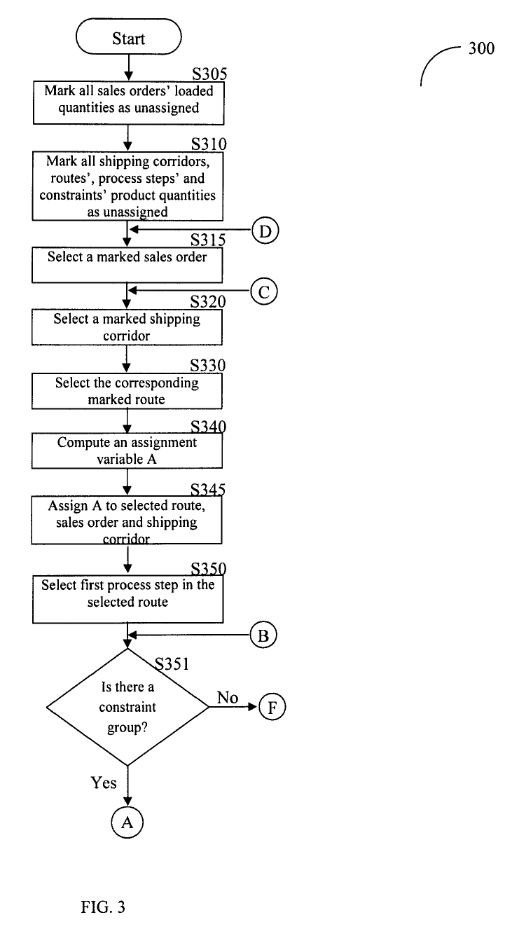

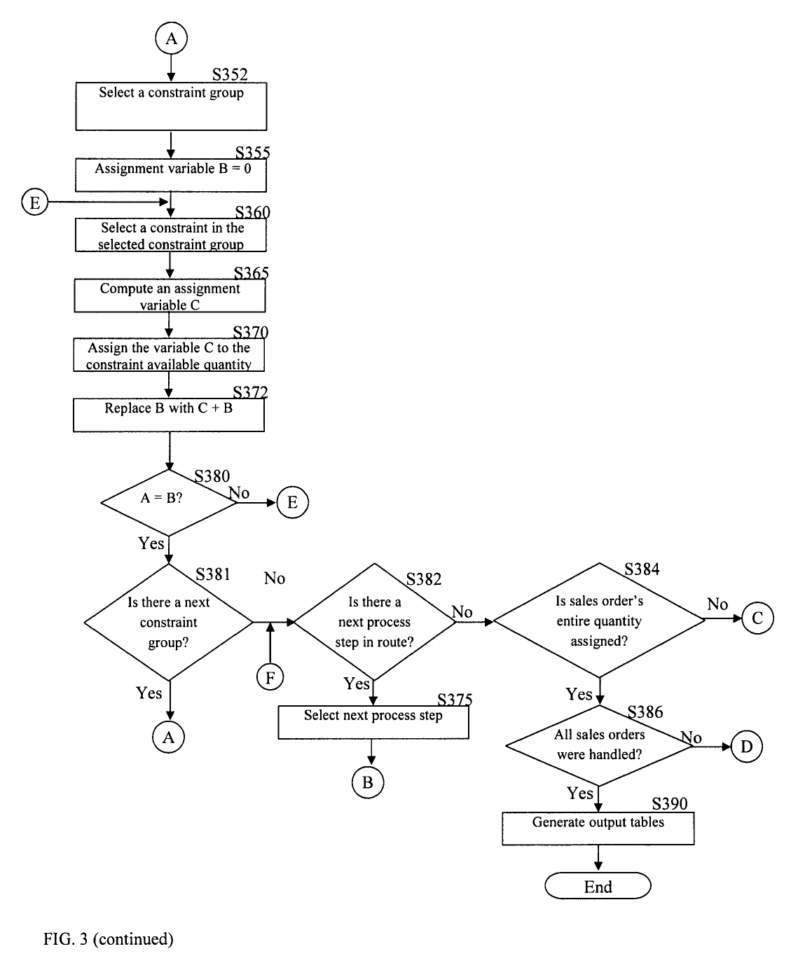

Referring now to FIG. 3, an exemplary and non-limiting flowchart 300, describing the process for generating the Sales Order Route Loading and Sales Order Constraint Loading tables, is shown. The input of this process is the outputs of S115. At S305, all sales orders' loaded quantities in Table 230 are marked as unassigned. At S310, all shipping corridors in Table 250 as well as product quantities of routes in Table 220, process steps and constraints in Table 210 are marked as unassigned. A shipping corridor for a product is composed of a deliver-to location and a ship-from location. The deliver-to location is an attribute of the sales order, for example, the San Francisco, Calif. Airport. The ship-from location is an attribute of the end of the route, for example, a plant located in Fresno, Calif. At S315, a marked sales order is selected from Table 230.

At S320, a marked shipping corridor that delivers to the sales order's delivery location is selected. That is, for combination of a sales order's product and deliver-to-location, any marked corridor (i.e., a combination of product, route, and deliver-to-location) with unassigned quantity is selected from Table 250. It should be noted that if the shipping corridor has associated constraints, the shipping corridor is instead represented as a process step, where the constraints are set as the constraint group of the process step. At S330, the corresponding marked route is selected from Table 220.

At S340, a first assignment variable “A” is set to the minimum of the unassigned quantity of the selected sales order, the unassigned quantity of the selected shipping corridor, and the unassigned quantity of the selected route. It should be noted that the selected shipping corridor and route refer to a product of the selected sales order. At S345, the value of the variable A is assigned to the selected sales order, shipping corridor, route, and all process steps of the selected route. For example, if the unassigned quantities of the sales order, shipping corridor, and route are respectively 100, 120, and 90 units of a sales order's product, then the quantity 90 is assigned to this specific route, with the remainder of the sales order's quantity to be assigned to a different route later. 33 At S350, a first process step in the selected route is determined. At S351, it is determined whether the selected process step has one or more constraint groups, and if so execution continues with S352; otherwise, execution proceeds to S382. At S352, the next constraint group that has not been processed for this sales order is selected and, at S355, a second assignment variable “B” is initialized to zero. At S360, a constraint in the constraint group with unassigned quantity of the sales order product is selected. At S365, a third variable “C” is set to the minimum assignment variable A minus assignment variable B, and the unassigned quantity of sales order's product of the selected constraint, i.e.,

C=minimum {(A−B), constraint's unassigned quantity of sales order 's product}

At S370, the value of the variable C is assigned to the unassigned quantity of the selected constraint. In addition, at S372, the value of the assignment variable C is assigned to the value of the variable B (i.e., B←B+C, or B is set to B+C).

At S380, a check is made to determine if the assignment variable B equals to the assignment variable A, and if so, execution continues with S381; otherwise, execution returns to S360. At S381, another check is made to determine if there is a subsequent constraint group in the selected process step and, if so, execution returns S352 where the next constraint group is selected; otherwise, execution continues with S382.

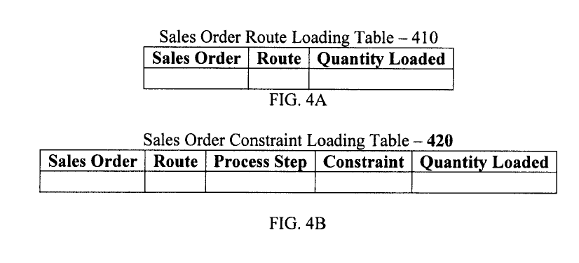

At S382, another check is made to determine if there is a subsequent process step in the selected route, and if so execution continues with S375 where the next process step is selected, and thereafter execution continues with S351, where it is determined if there is a constraint group for the now selected process step; otherwise, execution continues with S384 where it is determined if the entire quantity of the selected sales order is assigned to constraint(s), a route and a shipping corridor. If so, execution proceeds to S386; otherwise, execution returns to S320. At S386, a check is made to determine if all sale orders were handled, and if so execution continues with S390; otherwise, execution returns to S315 where another sales order with unassigned quantity is selected. At S390, the Sales Order Route Loading and Sales Order Constraint Loading tables are generated using the constraint(s), route(s) and process step(s) to each sales order. As shown in FIG. 4A, a Sales Order Route Loading table 410 includes the fields: sales order, route, and quantity loaded. A Sales Order Constraint Loading table 420 provided in FIG. 4B includes the fields: sales order, route, process step, constraint, and quantity loaded.

It should be noted that the process 300 stays within the quantities resulting from a linear program, so the sum of the loaded quantities for all sales orders for a process step and a constraint always equals to volume loaded on each process step and constraint for all products.

In another embodiment of the present invention, a steps-and-transfers approach is used to generate the tables similar to those shown in FIG. 4A and 4B. In the steps-and-transfers approach, individual process steps are modeled, possible product transfers between process steps are identified, and the abilities of specific constraints at certain steps to produce specific products are identified. Sequences of steps (i.e., routes) to produce individual products are not pre-specified. It would be apparent to a person skilled in the art that a similarly recursive routine can be constructed to assign loaded sales order quantities to process steps and constraints.

Referring back to FIG. 1, at S130, a loading plan of non-loaded sales order quantities is determined. Specifically, as opposed to any prior art techniques, the quantities not loaded of sales orders are identified and assigned to their least opportunity cost routes and constraints. Typically, the loading step (e.g., step S115) assigns only sales order quantities in the optimal mix to constraints. The optimal mix is determined by an optimization engine using the market and production data.

In accordance with one embodiment, a loading plan of non-loaded sales order quantities is generated using reduced cost data. This is performed by using sensitivity (i.e., reduced cost) information on decision variables to find the most optimal assignment of a sales order to routes and constraints. The decision variables may include, for example, volume loaded of a sales order, volume loaded of a product for a customer location, volume loaded of a product for a customer location on a route, volume loaded of a product on a route, and volume loaded of a product on a route for a process step on a constraint within a constraint group. Non-loaded sales order quantities are assigned to feasible combinations of routes, process steps, and constraints within constraint groups based on sums of their decision variables' reduced costs, i.e., the non-loaded quantity of a sales order is assigned to its least opportunity cost combination.

In another embodiment of the present invention, sales orders not included in the optimal mix are assigned to constraints and routes by running an optimization engine, while forcing the engine to add a portion of each such sales order to the optimal mix. This can be performed, for example, by assigning a very small minimum quantity to every sales order. Once the sales orders are added to the optimal mix, the loading process described at S120 assigns the volume loaded to a route or constraint, and any non-loaded volume is assigned to the same routes, process steps, and constraints corresponding to a sales order's loaded quantity. It should be noted that in the case where a sales order is partially fulfilled, and the sales order is loaded on multiple routes or multiple constraints within a process step, the non-loaded quantity will be assigned to routes, process steps, and constraints in the same proportions as the optimally loaded quantities.

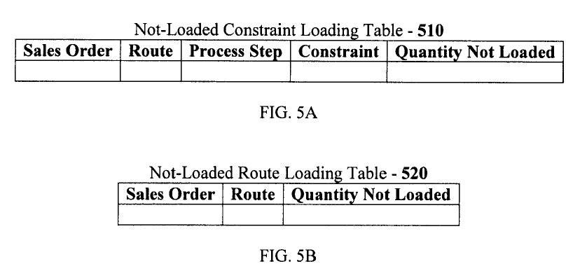

The outcome of step S130 is a Sales Order Quantity Not-Loaded Constraint Loading table 510 and a Not-Loaded Sales Order Quantity Route Loading table 520 which are shown in FIGS. 5A and 5B respectively. The table 510 includes the fields: sales order, route, process step, and quantity not loaded. The table 520 includes the fields: sales order, route, constraints and quantity not loaded.

Referring back to FIG. 1, at S140, the details of the generated constraint loading plan are output. Specifically, these details are arranged in a table that includes at least the fields: sales order, customer, product, route, process step, constraint, quantity loaded, quantity not loaded, constraint units per unit, process step cash contribution per constraint unit, adjusted process step cash contribution per constraint unit, and constraint (or constraint) marginal cash contribution per constraint unit.

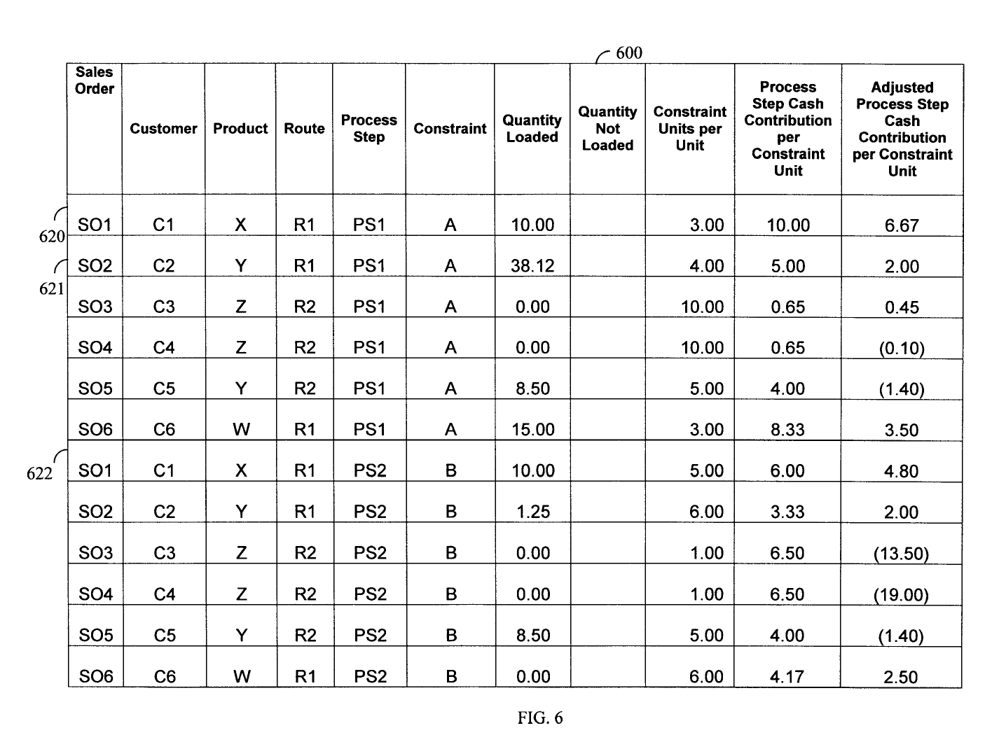

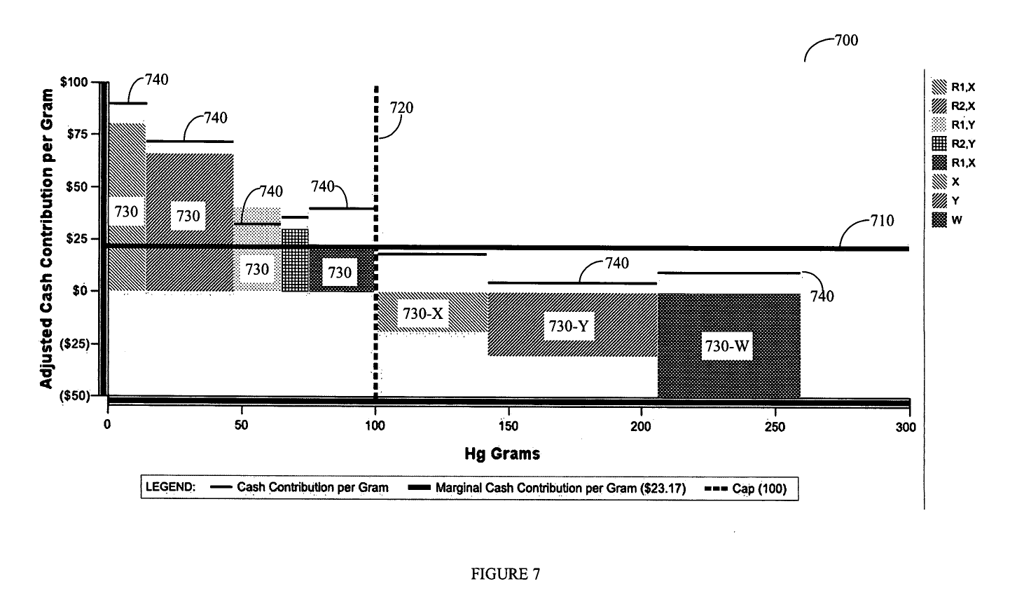

An exemplary output table 600 is provided in FIG. 6. The table 600 splits a sales order (column 601) data into Quantity Loaded and Quantity Not Loaded rows. If the respective quantity in one row is positive, then its value in the other row is zero, for example, rows 620 and 622. The sum of all Quantity and Quantity Not Loaded in all rows for a sales order equals to the sales order's maximum quantity. If there are sales orders with zero quantity loaded under an optimal plan, then the table 600 indicates the routes, process steps and constraints that would be used to load the sales orders if these sales orders were forced into production, while minimizing the negative impact on profitability (i.e., systemic cash contribution). For example, row 621 with a sales order “SO4” is an example of such a case. The sales order “SO4” had a Quantity loaded that equals to zero, i.e., products were not loaded; however, the route, process step, and constraint assigned to this sales order are R2, PS1, and A respectively.

The value of a Constraint Process Step Cash Contribution per Constraint Unit in table 600 is calculated for a given sales order on a route at a process step on a constraint of the respective row. The calculation is performed using the following equation:

Constraint Process Step Cash Contribution per Constraint Unit=Sales Order 's Cash Contribution per Unit/Constraint Units per Unit for the selected constraint to load the product at the process step

As mentioned above multi-period planning can be performed to solve at least constraint loading with inventory problems. In such a case, the Constraint-Process Cash Contribution per Constraint Unit for a given “current” period is calculated as follows:

Constraint Process Step Cash Contribution per Constraint Unit=(sales order's Price−sales order's Variable Cost)/Constraint Units per Unit for the selected constraint to load the product at the process step

where, the sales order's Price is discounted to the current period. Similarly, if inventory exists prior to the current planning period, the inventory's Variable Cost is a sunk cost, and the same equation, with a non-discounted Price and Variable Cost replaced by 0, is applied to compute the Constraint Process Step Cash Contribution per Constraint Unit.

The Constraint-Process Step Adjusted Cash Contribution per Constraint Unit is calculated for a given sales order on a route at a process step on a constraint of the respective. The calculation is performed, for example, using the following equation:

Constraint−Process Step Adjusted Cash Contribution per Constraint Unit=(Sales Order's Marginal Cash Contribution per Unit/Constraint Units per Unit for the selected constraint to load the product at the process step)+Constraint Marginal Cash Contribution per Constraint Unit

The Constraint Process Step Marginal Cash Contribution per Constraint Unit is calculated for a given Sales Order on a route at a process step on a constraint. The calculation is performed, for example, using the following equation:

Constraint Process Step Marginal Cash Contribution per Constraint Unit=Sales Order 's Marginal Cash Contribution per Unit/Constraint Units per Unit

The “Constraint Units per Unit” parameter is for the selected constraint to produce the product at the process step.

It should be noted that a sales order's Marginal Cash Contribution per Unit reflects information about the timing of when the sales order's product was loaded and when the sales order was sold. As mentioned above, inventory could be built in a prior planning for use by the sales order in the current period, and appropriate inflating of variable costs would be reflected in the Marginal Cash Contribution per Constraint Unit.

It would be apparent to a person skilled in the art that the tables and their content can be presented in the form of charts, or any other tangible format in print, display, or otherwise.

In a preferred embodiment of the present invention, the outputs generated by the process 100 can be displayed through a plurality of charts including, but not limited to, a constraint loading chart, a cash contribution breakdown chart, a displaced-cash by constraint chart, and a topographical marginal cash contribution per unit chart. The constraint loading chart displays the cumulative constraint units versus the constraint process step adjusted cash contribution per minute for each combination of a product, route and process step. The cash contribution breakdown chart shows the marginal cash contribution per unit for sales orders. The displaced-cash by constraint chart indicates how much of the given cash contribution of a product-process step-route combination can be displaced at another constraint. The topographical chart presents the actual versus plan marginal cash contribution per unit.

The following is a non-limiting example describing the constraint loading chart of an emissions cap constraint (“emissions cap loading chart”) generated in accordance with the invention. A chemical plant produces a series of products (X, Y, W) on two different routes (R1 and R2). The plant may emit up to 100 grams of mercury (Hg), i.e., the emissions cap constraint is 100 grams of Hg. The method generates an emissions cap loading chart 700 that represents the loading of a product and route combination. Specifically, the chart 700 displays the cumulative emitted grams of Hg versus the constraint process step adjusted cash contribution per constraint unit for each combination of product and route. The x-axis is the cumulative number of grams of Hg loaded onto the constraint. The y-axis is the adjusted cash contribution per gram. The vertical line 710 shows the emissions cap (100 grams) and the horizontal line 720 is constraint's marginal cash contribution per gram.

Each bar 730 represents the emissions for a product-route combination (i.e., a product-route or a product). The bars 730 are presented in decreasing order of adjusted cash contribution per constraint unit. As can be clearly noticed from chart 700, it is more profitable to load product X on Route R2 (represented by bar 730-2), rather product Y on Route R2 (represented by bar 730-2). The horizontal lines 740 represent cash contribution per gram. The difference between the green lines 740 and the tops of the bars 730 is the cash displaced on other constraints, converted into the appropriate cash contribution per gram of Hg units. The chart 700 further shows that products are produced until the Hg limit is reached (or adjusted cash contribution per gram is zero). That is, the bars 730-X, 730-Y, and 730-W represent products that were not produced.

The chart 700 can be utilized to determine the additional cash contribution that could be made if a specific constraint is relaxed. For example, from chart 700, if the emission cap is increased by one unit, one more unit of emission is allowed. The marginal cash contribution per constraint unit estimates of how much cash contribution is increased per unit of increase in the emission cap.

The methods and processes described herein can be implemented in software, hardware, firmware or any combination thereof wherein the software is intended to operate with respect to a system for execution of the software instructions. The software may be further included in a product that contains a plurality of instructions on a computer readable medium, the instruction, when used by a device such as a computer, causes the execution of the instructions and as a result executing the methods disclosed herein above. One of skill in the art would recognize that the practicalities associated with the disclosed method require a computer be used to perform the computation. A computer for the purposes of this discussion may be simply understood as a processor and an associated tangible memory storing instructions. As is well known, the instructions are performed by the processor. Thus, in other words, an embodiment of the invention resides in a tangible computer memory storing instructions for optimizing business plans, which instructions, when executed by the computer processor, enable the processor to perform certain functions as set forth below. The method is thus an automated or computer implemented method (although, of course, interaction with users, either human or other computer systems, to one degree or another is foreseen).

What is claimed is:

1. A computer implemented method for generating an optimized constraint loading plan, comprising:
receiving constraint information regarding at least one constraint;
using collected business data of an organization;
generating a loading plan of products;
generating a loading plan of loaded sales orders quantities;
generating a loading plan of non-loaded sales orders quantities; and
outputting the optimized constraint loading plan.

2. The computer implemented method of claim 1, where the business data comprises at least one of: finance data, marketing data, and sales data.

3. The computer implemented method of claim 2, wherein the business data is based on at least one of: historical details and projected details.

4. The computer implemented method of claim 1, wherein the constraint information comprises at least applicability of constraints to certain products, constraint units required per product unit, and constraint limits.

5. The computer implemented method of claim 4, wherein the constraint comprises at least one of the following constraints: an emissions cap constraint, a resource-based constraint, and a market-based constraint.

6. The computer implemented method of claim 1, wherein generating the loading plan of products further comprises assigning of products to at least one constraint.

7. The computer implemented method of claim 6, further comprises assigning combinations of products, routes, and process steps to the at least one constraint.

8. The computer implemented method of claim 7, wherein the loading plan of products is generated using a mathematical programming engine.

9. The computer implemented method of claim 1, wherein generating the loading plan of loaded sales orders quantities further comprises:
for each sales order:
assigning the quantities loaded of the sales order to a least one route and its process steps; and
assigning the quantities loaded of the sales order to a least one constraint in each of the process steps of the route.

10. The computer implemented method of claim 1, wherein generating the loading plan of loaded sales orders quantities further comprises:
modeling individual process steps;
identifying possible product transfers between the modeled process steps; and
identifying constraints operating with the modeled process steps to produce a product that can be transferred between the modeled process steps.

11. The computer implemented method of claim 10, wherein generating the loading plan of non-loaded sales orders quantities further comprises:
for each sales order:
assigning the non-loaded quantities of the sales order to a least one route and its associated process steps according to the least opportunity cost of the sales order; and
assigning the non-loaded quantities of the sales order to at least one constraint for each of the route's process steps according to the least opportunity cost of the sales order.

12. The computer implemented method of claim 1, wherein outputting the optimized constraint loading plan comprises the production of at least one of the following outputs: a sales order, a customer, a product, a route, a process step, an constraint, a quantity loaded, a quantity not loaded, a constraint units per unit, a process step cash contribution per constraint unit, an adjusted process step cash contribution per constraint unit, and an constraint marginal cash contribution per constraint unit.

13. The computer implemented method of claim 11, wherein the outputs further indicate, for sales orders with quantities not loaded, the routes, process steps and constraints that would be used to produce the sales orders' non-loaded quantities if the quantities were forced into production.

14. The computer implemented method of claim 11, wherein outputting the optimized constraint loading plan comprises the production of at least one of the following outputs: a constraint loading chart, an emissions cap loading chart, a cash contribution breakdown chart, a displaced-cash by constraint chart, a topographical chart of a marginal cash per unit.

15. The computer implemented method of claim 14, wherein the outputs are displayed or printed.

16. The computer implemented method of claim 1, further comprising determining the additional cash contribution be made if the at least one constraint is relaxed.

17. A computer program product for generating an optimized constraint loading plan, the computer program product having computer instructions on a tangible computer readable medium, the instructions being adapted to enable a computer system to perform operations, comprising:
receiving constraint information regarding at least one constraint;
using collected business data of an organization:
generating a loading plan of products;
generating a loading plan of loaded sales orders quantities;
generating a loading plan of non-loaded sales orders quantities; and
outputting the optimized constraint loading plan.

18. The computer program product of claim 17, where the business data comprises at least one of: finance data, marketing data, and sales data.

19. The computer program product of claim 18, wherein the business data is based on at least one of: historical details and projected details.

20. The computer program product of claim 17, wherein the constraint information comprises at least applicability of constraints to certain products, constraint units required per product unit, and constraint limits.

21. The computer program product of claim 20, wherein the constraint comprises at least one of the following constraints: an emissions cap constraint, a resource-based constraint, and a market-based constraint.

22. The computer program product of claim 17, wherein generating the loading plan of products further comprises the assigning of products to at least one constraint.

23. The computer program product of claim 22, further comprising assigning combinations of products, routes, and process steps to the at least one constraint.

24. The computer program product of claim 23, wherein the loading plan of products is generated using a mathematical programming engine.

25. The computer program product of claim 17, wherein generating the loading plan of loaded sales orders quantities further comprises:
for each sales order,
assigning the quantities loaded of the sales order to a least one route and its process steps; and
assigning the quantities loaded of the sales order to a least one constraint in each of the process steps of the route.

26. The computer program product of claim 17, wherein generating the loading plan of loaded sales orders quantities further comprises:
modeling individual process steps;
identifying possible product transfers between the modeled process steps; and
identifying constraints operating with the modeled process steps to produce a product that can be transferred between the modeled process steps.

27. The computer program product of claim 26, wherein generating the loading plan of non-loaded sales orders quantities further comprises:
for each sales order:
assigning the non-loaded quantities of the sales order to a least one route and its associated process steps according to the least opportunity cost of the sales order; and
assigning the non-loaded quantities of the sales order to at least one constraint for each of the route's process steps according to the least opportunity cost of the sales order.

28. The computer program product of claim 17, wherein outputting the optimized constraint loading plan comprises the production of at least one of the following outputs: a sales order, a customer, a product, a route, a process step, an constraint, a quantity loaded, a quantity not loaded, a constraint units per unit, a process step cash contribution per constraint unit, an adjusted process step cash contribution per constraint unit, and an constraint marginal cash contribution per constraint unit.

29. The computer program product of claim 27, wherein the outputs further indicate, for sales orders with quantities not loaded, the routes, process steps and constraints that would be used to produce the sales orders' non-loaded quantities if the quantities were forced into production.

30. The computer program product of claim 27, wherein outputting the optimized constraint loading plan comprises the production of at least one of the following charts: a constraint loading chart, an emissions cap loading chart, a cash contribution breakdown chart, a displaced-cash by constraint chart, a topographical chart of a marginal cash per unit.

31. The computer program product of claim 30, wherein the outputs are displayed or printed.
